(19) United States
(12) Patent Application Publication
(10) Pub. No.: US 2014/0119032 A1
(43) Pub. Date: May 1, 2014

(54) LED LIGHT

(71) Applicants: Frank Wimbert, Owen (DE); Philip Hupfer, Burgthann (DE)

(72) Inventors: Frank Wimbert, Owen (DE); Philip Hupfer, Burgthann (DE)

(73) Assignee: Flextroncis Automotive GmbH & Co KG, Rickenhausen (DE)

(21) Appl. No.: 14/129,243

(22) PCT Filed: Jun. 21, 2012
(86) PCT No.: PCT/EP2012/061957

§ 371 Date: Dec. 24, 2013

(30) Foreign Application Priority Data
Jun. 28, 2011 (DE) 202011050563.4

(51) Int. Cl. F21V 19/00

(52) U.S. Cl. CPC F21V 19/003
USPC 362/311.02

(57) ABSTRACT

With an LED lamp (1; 21), particularly a refrigerator lamp or the like, comprising at least one LED (2), an optics (4; 22) for the light emitted by the at least one LED (2) and an opaque lamp housing (5) that surrounds the optics (4; 22), it is provided according to the invention that the optics (4; 22) is designed to be transmissive and the opaque lamp housing (5) and the transmissive optics (4; 22) are jointly composed of a two-component plastic injection-moulded part (6).

The present invention relates to an LED lamp, particularly a refrigerator lamp or the like, comprising at least one LED, an optics for the light emitted by the at least one LED and an opaque lamp housing that surrounds the optics.

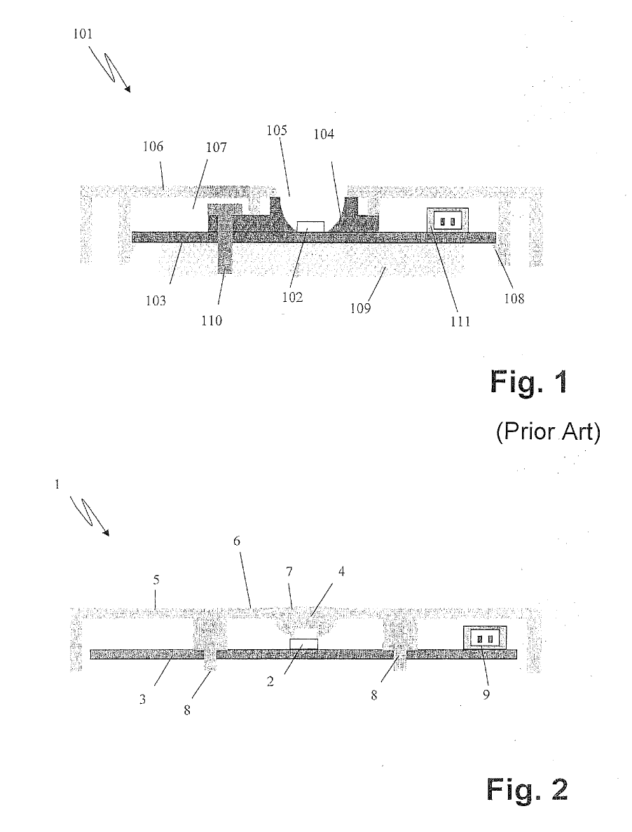

FIG. 1 shows a known LED refrigerator lamp 101 comprising an LED 102 which is arranged on a circuit board 103. The LED 102 is surrounded by a reflector 104 which directs the light emitted by the LED 102 forwards through a housing opening 105 of an opaque lamp housing 106 covering the circuit board 103. The lamp housing 106 comprises a latching-type receiving means 107, in which the circuit board 103 is received and locked in place by means of a plurality of locking catches 108. An aluminium cooling element 109 for cooling the LED 102 is arranged on the side of the circuit board opposite the LED 102. The reflector 104 is arranged between the circuit board 103 and the lamp housing 106 and screwed onto the aluminium cooling element 109 by means of a screw 110, as a result of which the reflector 104 and the cooling element 109 are clamped to the circuit board 103 lying therebetween. To connect the LED 102 to a power supply, the circuit board 103 has a plug connector 111.

When assembling the LED refrigerator lamp 1, the circuit board 103, the reflector which has been previously plated with its reflection layer in a further production step, and also the cooling element 109 are screwed to one another by means of the screw 110.

On the other hand, the problem addressed by the present invention is that of reducing the number of components in an LED lamp of the kind referred to above and simplifying the assembly.

This problem is solved according to the invention in that the optics is designed to be transmissive and the opaque housing and the transmissive optics are jointly composed of a two-component plastic injection-moulded part. The transmissive optics is preferably designed as collimator optics or as an optical lens, particularly a Fresnel lens, or as light-scattering diffusor optics or as light-guiding optics or as a light disk without a collimator or diffusor effect.

On account of the two-component plastic injection-moulded part with moulded transmissive optics according to the invention, the previous reflector-plating, the previous screw and the previous assembly of the reflector, circuit board, cooling element and screw can be dispensed with. Due to the greater efficiency of LEDs available today, a cooling element is no longer required either.

For additional beam shaping, the outside of the transmissive optics is designed to be smooth or comprises structures, such as with eroding structures, pillow optics, cylinder lens segments, etc.

The two-component plastic injection-moulded part is preferably locked in place with a circuit board comprising the at least one LED by means of a locking catch on the housing side, for example, or staked by means of guide cupolas on the housing side, for example. Furthermore, the two-component plastic injection-moulded part—and therefore the collimator optics—can be exactly positioned in relation to LED via projections which engage in a custom-fit manner with holes in the circuit board.

Advantageous embodiments of the invention are the subject-matter of the dependent claims. Further advantages of the invention result from the description and the drawing. Likewise, the features mentioned above and those listed below may each apply separately or in a plurality in any combinations. The embodiments shown and described must not be regarded as a definitive list, but instead are exemplary in nature, intended to describe the invention.

In the figures:

FIG. 1 shows an LED lamp according to prior art;

FIG. 2 shows a first embodiment of the LED lamp according to the invention; and

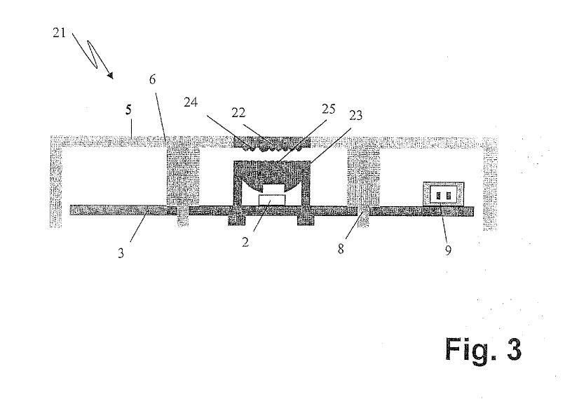

FIG. 3 shows a second embodiment of the LED lamp according to the invention.

The LED refrigerator lamp 1 shown in FIG. 2 comprises an LED 2 (or also a plurality of LEDs), which is arranged on a circuit board 3. A transmissive optics in the form of collimator optics 4 or an optical lens (e.g. Fresnel lens) is arranged in front of the LED 2, which optics directs the light emitted by the LED 2. The collimator optics 4 is formed along with an opaque lamp housing 5 covering the circuit board 3 by a two-component plastic injection-moulded part 6. The collimator optics 4 is made of transparent plastic and the lamp housing 5 of opaque plastic.

The outside of the collimator optics 4 may be smooth or, as shown in FIG. 2, it may comprise structures 7, e.g. eroding structures, pillow optics or cylinder lens segments, for additional beam shaping.

The plastic injection-moulded part 6 engages in a custom-fit manner with holes in the circuit board 3 using projections (guide cupolas) 8 which are provided on the lamp housing 5, as a result of which the collimator optics 4 and the LED 2 are exactly positioned relative to one another. The circuit board 3 lies on ledges of the projections 8, wherein the projections 8 are staked to fasten the circuit board 3. Alternatively, locking catches may be moulded onto the lamp housing 5—in a similar manner to FIG. 1—in order to lock the circuit board 3 in place on the plastic injection-moulded part 6. To connect the LED 2 to a power supply, the circuit board 3 has a plug connector 9.

The LED refrigerator lamp 21 shown in FIG. 3 only differs from the LED refrigerator lamp 1 in FIG. 2 in that the transmissive optics, which is formed by a two-component plastic injection-moulded part 6 along with the opaque lamp housing 5 covering the circuit board 3, is formed in this case as diffusor optics 22 in the form of a light-scattering diffusor plate and that between the LED 2 and the diffusor plate 22 a separate transmissive collimator optics 23 or a separate optical lens (e.g. Fresnel lens) is staked or clipped onto the circuit board 3. For further beam shaping, the diffusor plate 22 comprises internal optical structures (e.g. pillow optics, cylinder lenses, eroding structure, . . . ) 24. In addition or alternatively, the diffusor plate 22 may also comprise external optical structures (not shown). The diffusor plate 22 may be configured in the two-component plastic injection-moulded part 6 as a milky plastic component, for example. The outside of the collimator optics 23 may be smooth or, as shown in FIG. 3, it may comprise optical structures 25, e.g. eroding structures, pillow optics or cylinder lens segments, for additional beam shaping and guiding. Unlike the LED refrigerator lamp 1, the LED refrigerator lamp 21 therefore has at least two optically effective surfaces, namely the internal optical structures 24 of the diffusor plate 22 and the optical structures 25 of the collimator optics 23, in order to homogenize the light emitted by the LED 2 even more effectively, if necessary.

Patent claims:

1. LED lamp (1; 21), particularly a refrigerator lamp or the like, comprising at least one LED (2), an optics (4; 22) for the light emitted by the at least one LED (2) and an opaque lamp housing (5) that surrounds the optics (4; 22), characterized in that the optics (4; 22) is designed to be transmissive and the opaque lamp housing (5) and the transmissive optics (4; 22) are jointly composed of a two-component plastic injection-moulded part (6).

2. LED lamp according to claim 1, characterized in that the transmissive optics is designed as diffusor optics (22).

3. LED lamp according to claim 1, characterized in that the transmissive optics is designed as a light-guiding optics.

4. LED lamp according to claim 1, characterized in that the transmissive optics is designed as a light disk.

5. LED lamp according to claim 1, characterized in that the transmissive optics is designed as collimator optics (4) or an optical lens, particularly a Fresnel lens.

6. LED lamp according to one of the preceding claims, characterized in that the inside of the transmissive optics (4; 22) is designed to be smooth or comprises structures (7; 24) for additional beam shaping.

7. LED lamp according to one of the preceding claims, characterized in that the outside of the transmissive optics (4; 22) is designed to be smooth or comprises structures (7; 24) for additional beam shaping.

8. LED lamp according to one of the preceding claims, characterized in that the two-component injection-moulded part (6) is locked in place or staked with a circuit board (3) comprising the at least one LED (2).

9. LED lamp according to one of the preceding claims, characterized in that the two-component plastic injection-moulded part (6) is exactly positioned in relation to the at least one LED (2) via projections (8) which engage in a custom-fit manner with holes in a circuit board (3) comprising the at least one LED (2).

10. LED lamp according to claim 9, characterized in that the projections (8) are staked to fasten the circuit board (3).

11. LED lamp according to one of the preceding claims, characterized in that between the at least one LED (2) and the transmissive optics (22) a transmissive collimator optics (23) or an optical lens, particularly a Fresnel lens, is fastened, particularly staked or clipped, onto the circuit board (3).
